(19) United States
(12) Patent Application Publication
(10) Pub. No.: US 2015/0144636 A1
(43) Pub. Date: May 28, 2015

(54) ENCLOSURE STRUCTURE FOR CANS AND PROCESS FOR MACHINING SAME

(71) Applicant: ZHEJIANG CHANCING PACKAGE MATERIAL CO., LTD., Jiaxing (CN)

(72) Inventors: Yuhou Zong, Jiaxing (CN); Haiping Zhou, Jiaxing (CN)

(21) Appl. No.: 14/407,418

(22) PCT Filed: Mar. 13, 2013
(86) PCT No.: PCT/CN2013/072517

§ 371 Date: Dec. 11, 2014

(30) Foreign Application Priority Data
Jul. 13, 2012 (CN) 201210241174.8

(51) Int. Cl. B65D 17/50; B65D 17/00; B29C 70/80; B21D 51/44; B21D 51/46

(52) U.S. Cl. CPC B65D 17/502; B21D 51/443; B21D 51/46; B29C 70/80; B65D 17/02
USPC 220/359.2; 220/359.4; 413/14; 413/18

(57) ABSTRACT

The present invention discloses a can, and provides an enclosure structure for cans with advantages of simple enclosure, low cost, safe and hygienic assurance and opening easiness, as well as a process for machining such an enclosure structure. The present invention solves technical problems in the prior art that pull-outward tabs are easy to break and hard to open while fold-inward tabs have poor safety and hygienic assurance. The enclosure structure of the present invention comprises a top cover of a can, an opening being provided on the top cover. An annular closed boss is provided on an outer edge of the opening; an enclosure covering plate is provided on the annular closed boss; a plastic film is provided on an upper end surface, corresponding to the enclosure covering plate, of the annular closed boss; and the enclosure covering plate is connected in a sealed manner to an upper port of the annular closed boss via the plastic film.

### TECHNICAL FIELD

The present invention relates to a can, in particular to an enclosure structure for cans with advantages of simple enclosure, low cost, safe and hygienic assurance and opening easiness, as well as a process for machining such an enclosure structure.

### BACKGROUND OF THE PRESENT INVENTION

As press-molded and then mechanically filled on the production line, cans have advantages of quick and convenient filling, good isolation and long shelf life, and are convenient and safe for transportation, not easy to damage, easy to carry around, easy to recycle and low in package cost. Hence, cans are widely used for packaging beer, carbonated beverages, juice and the like. Globally, the market of cans is mainly distributed in the developed countries and regions, and Europe and the United States and other developed countries are the main areas for both consumption and production. In recent years, with the rapid development of economy, the can industry in China develops fast too, and the demand of cans is increasing. More than 18 million tons of beer is made in China, ranking second in the world, 5% of which is packaged by cans, about 1.5 billions to 2 billions of cans. Meanwhile, juice beverages and multifunctional beverages, mainly being natural ingredients, containing various vitamins, an appropriate amount of protein and amino acids beneficial to people's health, become more and more popular, and such beverages also become large consumers of cans. As the existing enclosure structure for cans, a pull-toward enclosure structure and a fold-inward enclosure structure are generally included. The enclosure pull tabs in both structures cling to the top cover of a can. For the pull-outward enclosure structure, when in use, it is quite difficult to open the pull tab by a finger, and the pull tab is extremely easy to break; while for the fold-inward enclosure structure, fold-inward tabs have poor hygienic assurance. As the casing of a can is directly exposed in the environment, it is inevitable to have bacteria, dust and the like on the casing. When in use, the pull tab on the top cover will be folded into the can body and directly soaked into the liquid in the can body, contaminants such as bacteria and dust on the pull tab will contaminate the liquid in the can body. Hence, such a fold-inward enclosure structure has serious hazards.

Chinese Patent No. CN101670897A disclosed a drawn-type enclosure pull tab for cans. A U-shaped drawn groove is provided on an opening on the top of a can body, the drawn groove is provided with a drawn plate capable of sealing the opening, and a pull tab is provided on the outer side of the draw plate. Although in this structure the opening is blocked by providing a drawer-type drawn plate at the opening of the can, thereby avoiding problems that pull-outward tabs are easy to break and hard to open while fold-inward tabs have poor safety and hygienic assurance, this structure has deficiencies such as difficult molding, high production cost and poor sealing performance; and liquid in the can body is extremely easy to get out from the can when the can is placed upside-down. Hence, such a structure is not applicable to promotion and use in a large scope.

### SUMMARY OF THE PRESENT INVENTION

A major object of the present invention provides an enclosure structure for cans with advantages of simple enclosure, low cost, safe and hygienic assurance and opening easiness, as well as a process for machining such an enclosure structure. The present invention solves technical problems in the prior art that pull-outward tabs are easy to break and hard to open while fold-inward tabs have poor safety and hygienic assurance.

The technical problems mentioned in the present invention are mainly solved by the following technical solutions. A enclosure structure for cans is provided, including a top cover of a can, an opening being provided on the top cover, characterized in that an annular closed boss is provided on an outer edge of the opening; an enclosure covering plate is provided on the annular closed boss; a plastic film is provided on an upper end surface, corresponding to the enclosure covering plate, of the annular closed boss; and the enclosure covering plate is connected in a sealed manner to an upper port of the annular closed boss via the plastic film. By providing an annular closed boss on the edge of the opening of the can and covering an enclosure covering plate on the annular closed boss, as a plastic film is laminated by means of hot pressing or stuck on the annular closed boss, when in encapsulation, it is just needed to heat-seal, by a seamer, the enclosure covering plate onto the annular closed boss; and when the enclosure covering plate is to be opened, it is just needed to slightly pull and tear the enclosure covering plate. Such an enclosure structure is easy to open. Furthermore, by the enclosure covering plate, the liquid in the can body will not be contaminated, and instead it will be kept safe and hygienic. Encapsulating the opening of the can with a plastic film has the advantages of good sealing performance, simple machining process and low cost. By the annular closed boss, the strength of the opening is enhanced and the flatness of the enclosure is improved, so that the sealing performance of the enclosure of the can is further ensured. Meanwhile, by the annular closed boss, the liquid encapsulated in the can body is prevented from flowing through the upper surface of the top cover, when being poured out, to have the liquid contaminated. Hence, this structure ensures the liquid in the can body to be safe for drinking.

Preferably, the annular closed boss is integrally connected to the top cover. The opening of the can, when flanged outward, forms an integrally connected annular closed boss. The molding machining is simple; furthermore, the opening has good sealing performance and high strength.

Preferably, the plastic film on the upper end surface of the annular closed boss extends inward to the inner side of the top cover from the opening. By laminating by means of hot pressing or sticking a plastic film on the inner side of the top cover and then making the plastic film extend outward from the opening, an annular closed boss with a flanged structure is formed. This process is simple.

Preferably, the plastic film is a polyethylene film, a polypropylene film, a polyester film, a copolymer film of ethylene and acrylic monomers, a copolymer film of propylene and acrylic monomers, a copolymer film of ethylene and propylene, a copolymer film of ethylene and vinyl acetate or a composite film of the above films. The plastic film is low in cost, good in thermal plasticity, easy for machining, and safe and hygienic.

Preferably, the enclosure covering plate has a shape consistent to that of the opening, and the inside end of the enclosure covering plate extends inward and horizontally to form a pull top, the pull top being connected in an arc transition manner to the enclosure covering plate. By making the inside end of the enclosure covering plate extend inward to form a pull top, it is convenient to hand-hold and slightly pull the pull top up. When the pull top is connected in an arc transition manner to the enclosure covering plate, the pull top is prevented from breaking during the tearing process. The connection strength of the pull top and the enclosure covering plate is enhanced.

The opening may be in a circular shape, a water-drop shape or other shapes. Preferably, the opening is a long arc arranged in a radial direction. An opening in a long arc shape is convenient to be flanged upward to form an annular closed boss, and also convenient for a user to pour the liquid in the can body out in a constant speed.

Preferably, the top cover is made of tin or chrome-plated iron. Tin or chrome-plated iron is low in cost and simple in molding.

Preferably, the enclosure covering plate is made of aluminum-plastic composite material, paper-plastic composite material or plastic material. When the enclosure covering plate is made of aluminum-plastic composite material, paper-plastic composite material or plastic material, it can be ensured that the enclosure covering plate is heat-sealed on the annular closed boss, with good sealing performance, low cost and good water-proof performance. The leakage at the opening is avoided.

Preferably, a plastic film is provided on the upper surface of the top cover. Laminating or sticking a layer of film on the top cover, on one hand, prevents liquid poured out from the can body from contacting the metal surface of the top cover to do harm to human health, thus to improve the safety; and on the other hand, keeping the outer layer of the top cover free from corrosion, prolonging the service life of the can and guaranteeing the quality of liquid in the can body.

A process for machining the enclosure structure for cans includes the following steps of:

1) blanking a sheet into an enclosure covering plate;

2) performing surface pretreatment to a top cover with a sheet metal, and then laminating a plastic film onto the sheet metal to form a filmed metal plate;

3) blanking the filmed metal plate to form a top cover, and blanking an opening on the top cover;

4) flanging the opening outward to form an annular closed boss;

5) heat-sealing, by a seamer, the enclosure covering plate onto the annular closed boss;

6) connecting, by means of rolled-sealing, the top cover to the can body;

7) injecting, to the can body, liquid for encapsulation from a bottom cover on the bottom of the can body; and

8) finally, filling and sealing the bottom cover by a filling and sealing machine;

wherein, the order of execution of Step 1) and Step 2) can be changed, and Step 3) to Step 8) can be executed sequentially after Step 1) and Step 2).

Phosphorization pretreatment is performed to a sheet metal of tin or chrome-plated iron for manufacturing the top cover at first; a plastic film is laminated on the upper surface and lower surface of the sheet metal to form a filmed metal plate; the filmed metal plate is blanked to form a top cover with an opening; the opening is flanged outward to form an annular closed boss, with the plastic film facing upward; the enclosure covering plate is heat-sealed, by a seamer, onto the annular closed boss; the enclosed top cover is connected, by means of rolled-sealing, to the can body; liquid for encapsulation is injected, to the can body, from a bottom cover on the bottom of the can body; finally, the bottom cover is filled and sealed by a filling and sealing machine. The process is simple. Compared with the conventional processes, this process just needs to laminate by hot pressing or stick a plastic film on the inner side of the top cover, thus to realize the sealed connection between the top cover and the enclosure covering plate via the plastic film. This process has safe and hygienic assurance and low cost.

Preferably, after Step 2), the plastic film on the edge of the filmed metal plate is trimmed and recycled. The trimmed plastic film is recycled and reused. This is energy saving and environmentally friendly.

Preferably, after Step 5), leakage detection is executed. Leakage detection avoids any leakage at the connection of the top cover and the can body.

Preferably, the plastic film in the Step 2) is laminated on the sheet metal, by means of hot pressing by a laminating machine, or, with glue. Due to lamination by means of hot pressing or with glue, this process is simple.

In view of this, the enclosure structure for cans disclosed by the present invention has the following advantages:

first, laminating by means of hot pressing or sticking a plastic film, i.e., laminated steel, on the inner surface of a can keeps the inner chamber of the can free from corrosion;

second, as the edge of the long-arc opening of the top cover is flanged outward to form an annular closed boss, the plastic film laminated on the inner wall is flanged upward to be butt-enclosed with the enclosure covering plate, thereby making the molding simple and simplifying the machining process;

third, as made of aluminum-plastic composite material, paper-plastic composite material or plastic material, the enclosure covering plate has good water-proof performance, easy machining and low cost;

fourth, the enclosure operation is simple, and the enclosure structure is easy to open, safe and environmentally friendly, and good in leakage prevention; and fifth, the machining process is simple, reliable in sealing and low in cost.

### BRIEF DESCRIPTION OF THE DRAWINGS

FIG. 1 is a structural diagram of a first implementation manner of the present invention;

FIG. 2 is a cutaway view of FIG. 1;

FIG. 3 is a structural diagram of a second implementation manner of the present invention; and

FIG. 4 is a structural diagram of a third implementation manner of the present invention.

### DETAILED DESCRIPTION OF THE PRESENT INVENTION

The technical solutions of the present invention will be further described in details by embodiments with reference to the accompanying drawings.

### Embodiment 1

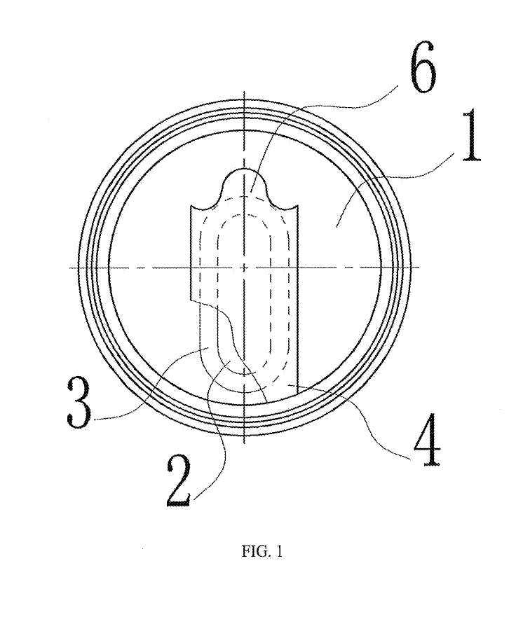

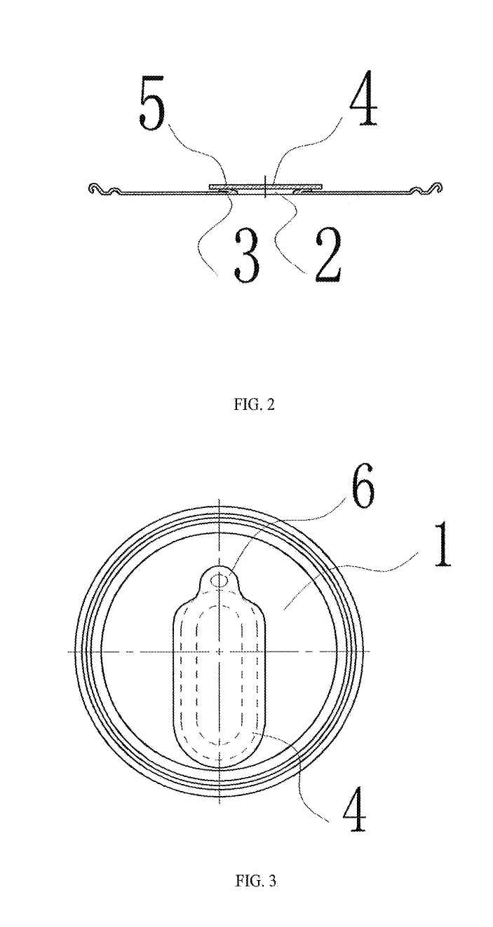

As shown in FIG. 1, an enclosure structure for cans is provided in the present invention, including a top cover 1 of a can, which is made of tin. As shown in FIG. 2, a plastic film 5 is laminated by means of hot pressing on the inner surface and outer surface of the top cover 1, respectively, the plastic film 5 being a polyethylene film. A long-arc opening 2 is provided on the top cover 1 in the radial direction, and one end of the opening 2 is close to the edge of the top cover 1. An annular closed boss 3 is formed integrally on the outside edge of the opening 2, that is, the annular closed boss 3 is formed by flanging the opening 2 outward. An enclosure covering plate 4 is covered on the annular closed boss 3. The enclosure covering plate 4 is made of aluminum-plastic composite material, the outside edge of the enclosure covering plate is a circular arc resisted against the edge of the top cover 1, while the inside edge thereof extends inward and horizontally to form a semi-circular pull top 6. The two sides of the pull top 6 are in arc transition to the enclosure covering plate 4.

A process for machining a can includes the following steps of:

1) blanking a sheet of aluminum-plastic composite material into an enclosure covering plate 4;

2) performing phosphorization pretreatment to a sheet metal of tin, laminating by a seamer a plastic film 5 onto the sheet metal of tin to form a filmed metal plate, and trimming and recycling the plastic film 5 on the edge of the filmed metal plate;

3) blanking a part of the filmed metal plate to form a circular top cover 1, blanking an opening 2 on the top cover 1, and flanging the opening 2 outward to form an annular closed boss 3);

4) stretching the other part of the filmed metal plate to form a can body, removing burrs on the can body and the top cover 1 and then cleaning, printing a pattern on the outer surface of the can body;

5) heat-sealing, by a seamer, the enclosure covering plate 4 onto the annular closed boss 3;

6) connecting, by means of rolled-sealing, the top cover 1 to the can body;

7) injecting, to the can body, liquid for encapsulation from a bottom cover on the bottom of the can body; and

8) finally, filling and sealing the bottom cover by a filling and sealing machine.

### Embodiment 2

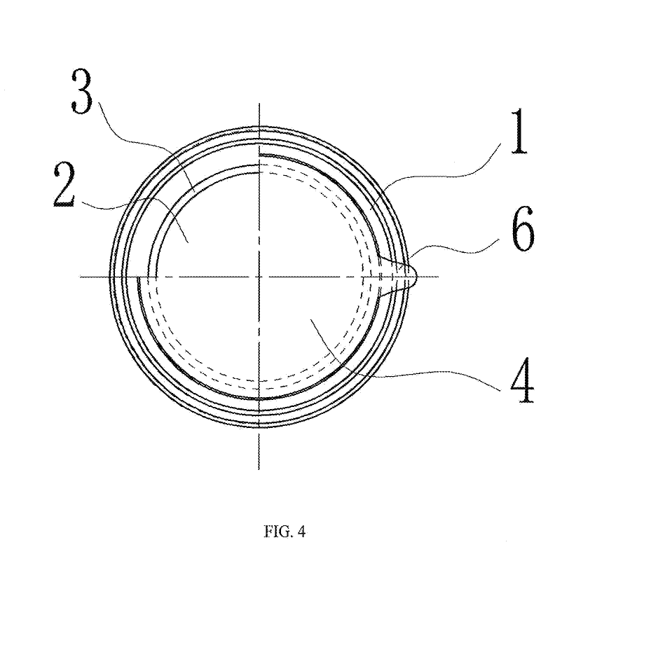

As shown in FIG. 3, a plastic film 5 is stuck on the inner surface and outer surface of the top cover 1 with glue, respectively. The plastic film 5 is a copolymer film of ethylene and acrylic monomers. The enclosure covering plate 5 has a shape consistent to that of the opening 2. Furthermore, a small hole is provided in the middle of the pull top 6, which is convenient for pulling the enclosure covering plate 4. The remaining is the same as Embodiment 1.

### Embodiment 3

As show in FIG. 4, a circular opening 2 is provided on the top cover 2, and the opening 2 is concentric to the top cover 1. Furthermore, the outer edge of the annular closed boss 3 formed by flanging the opening 2 outward is close to the edge of the top cover 1. The enclosure covering plate 4 is circular too, and the edge of the enclosure covering plate 4 extends to the outside of the edge of the annular closed boss 3.

The specific embodiments described herein merely illustrate the concept of the present invention. A person skilled in the technical art of the present invention may have various modifications or supplementations to the specific embodiments described above, or, may have the specific embodiments replaced by similar manners, without departing from the spirit of the present invention or going beyond the scope defined by the appended claims.

1. An enclosure structure for cans, comprising a top cover of a can, an opening being provided on the top cover, wherein an annular closed boss is provided on an outer edge of the opening; an enclosure covering plate is provided on the annular closed boss; a plastic film is provided on an upper end surface, corresponding to the enclosure covering plate, of the annular closed boss; and the enclosure covering plate is connected in a sealed manner to an upper port of the annular closed boss via the plastic film.

2. The enclosure structure for cans according to claim 1, wherein the annular closed boss is integrally connected to the top cover.

3. The enclosure structure for cans according to claim 1, wherein the plastic film on the upper end surface of the annular closed boss extends inward to the inner side of the top cover from the opening.

4. The enclosure structure for cans according to claim, wherein the plastic film is a polyethylene film, a polypropylene film, a polyester film, a copolymer film of ethylene and acrylic monomers, a copolymer film of propylene and acrylic monomers, a copolymer film of ethylene and propylene, a copolymer film of ethylene and vinyl acetate or a composite film of the above films.

5. The enclosure structure for cans according to claim 1, wherein the enclosure covering plate has a shape consistent to that of the opening, and the inside end of the enclosure covering plate extends inward and horizontally to form a pull top the pull top being connected in an arc transition manner to the enclosure covering plate.

6. The enclosure structure for cans according to claim 1, wherein the opening is a long arc arranged in a radial direction.

7. The enclosure structure for cans according to claim 1, wherein the top cover is made of tin or chrome-plated iron.

8. The enclosure structure for cans according to claim 1, wherein the enclosure covering plate is made of aluminum-plastic composite material, paper-plastic composite material or plastic material.

9. The enclosure structure for cans according to claim 1, wherein a plastic film is provided on the upper surface of the top cover.

10. A process for machining the enclosure structure for cans according to claim 1, comprising the following steps of:
1) blanking a sheet into an enclosure covering plate;
2) performing surface pretreatment to a top cover with a sheet metal, and then laminating a plastic film onto the sheet metal to form a filmed metal plate;
3) blanking the filmed metal plate to form a top cover, and blanking an opening on the top cover;
4) flanging the opening outward to form an annular closed boss;
5) heat-sealing, by a seamer, the enclosure covering plate onto the annular closed boss;
6) connecting, by means of rolled-sealing, the top cover to the can body;
7) injecting, to the can body, liquid for encapsulation from a bottom cover on the bottom of the can body; and
8) finally, filling and sealing the bottom cover by a filling and sealing machine;
wherein, the order of execution of Step 1) and Step 2) can be changed, and Step 3) to Step 8) can be executed sequentially after Step 1) and Step 2).

11. The process for machining the enclosure structure for cans according to claim 10, wherein, after Step 2), the plastic film on the edge of the filmed metal plate is trimmed and recycled.

12. The process for machining the enclosure structure for cans according to claim 10, wherein, after Step 5), leakage detection is executed.

13. The process for machining the enclosure structure for cans according to claim 10, wherein the plastic film in the Step 2) is laminated on the sheet metal, by means of hot pressing by a laminating machine, or, with glue.
